(19) United States
(12) Patent Application Publication
(10) Pub. No.: US 2009/0058761 A1
(43) Pub. Date: Mar. 5, 2009

(54) Navigation system and portable head up display thereof

(76) Inventors: Yu Chen, Taipei City (TW); Ching Hsiang Yu, Taipei City (TW); Tai-Sheng Yang, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/003,083

(22) Filed: Dec. 20, 2007

(30) Foreign Application Priority Data
Aug. 31, 2007 (TW) 096132672

(51) Int. Cl. G09G 5/00

(52) U.S. Cl. 345/7; 455/41.2

(57) ABSTRACT

This present invention provides a navigation system and a portable head up display thereof. The navigation system comprises a navigation apparatus and a portable head up display. The navigation apparatus is for generating a command with navigation message. The portable head up display is for receiving and processing the command with navigation message in wired or wireless manner, and then displaying the graphic data corresponding to the navigation message. Furthermore, the portable head up display is able to broadcast an acoustic data corresponding to the navigation message. Hereby, a user owning the personal navigation device (PND) can place this portable head up display in the vehicle, and the effectiveness of the navigation message displayed on the windshield can be achieved.

### FIELD OF THE INVENTION

The present invention relates to a navigation system, and more particularly to a navigation system integrated with a portable head up display.

### DESCRIPTION OF THE PRIOR ART

The navigation apparatus is getting popular at present, more and more drivers rely on the driving information provided from navigation apparatus, such as the map information, the destination route planning and the navigation information, etc. The navigation apparatus can be briefly categorized as motor vehicle navigation device and personal navigation device. Motor vehicle navigation device is built in vehicle computer once delivered from factory, where the screen and operation interface of motor vehicle navigation device are placed in the central panel of the vehicle. The personal navigation device is a portable electric device and is not connected with the motor vehicle computer. Such device can be used during walking and driving. However, such a navigation apparatus has a disadvantage of deviating the sight of the driver from the fore road by looking at a display of the navigation apparatus owing to the restriction of the display size or the display is improperly placed. Moreover, the driver must distract his/her attention from the fore road to the navigation apparatus for identifying the navigation message, the risk factor of driving is increased potentially.

In response to this problem aroused, a head up display is installed in front of driver seat for displaying navigation message, such as US Publication Number 6735517 “Windshield display for a navigation system”. As illustrated in FIG. 1, a head up display is combined with a motor vehicle navigation device and projects the navigation message on the windshield, as the rotation illustrated. However, the motor vehicle equipped with head up display is not popular, as it is designed for fewer higher class vehicles. Besides, more and more cellular phone has built-in navigation systems and the cellular phone is used for navigation while driving. Hence, how to have user enjoying the advantage of the head up display, and reduce the risk factor of driving, is an urgent issue to resolve.

According to the problem described above, the inventor of the invention herein conducted extensive research and experimentation that culminated in the successful development and design, hence a navigation system and a portable head up display thereof is addressed as the foundation and the realization for improving described problems.

### SUMMARY OF THE INVENTION

Therefore, it is one of objectives of the present invention to provide a navigation system and a portable head up display thereof to enhance the usability of the navigation system and the head up display.

According to the objective of present invention, the present invention provides a navigation system comprising a navigation apparatus and a portable head up display. The navigation apparatus is for generating a command with a navigation message. The portable head up display is for receiving and processing the command with navigation message, and then displaying a graphic data corresponding to the navigation message.

Preferably, the head up display can further broadcast the acoustic data corresponding to the navigation message.

Furthermore, the present invention further provides a head up display for displaying a navigation message from a remote navigation apparatus. The head up display comprises a power supply module, a data transmitting module, a display module, a storage module and a control module. The power supply module is for providing power for operation of the head up display. The data transmitting module is for receiving the command with navigation message. Said storage module is for storing plurality of graphic data. The control module coupled to the data transmitting module, the display module and the storage module. The control module is for processing the command in order to obtain navigation message and then selecting the graphic data corresponding to the navigation message from the storage module, and driving the display module to show the selected graphic data.

Preferably, the portable head up display can comprise an acoustic output module, and the storage module further stores a plurality of acoustic data, and the control module selects the acoustic data corresponding to the navigation message from the storage module, and the control module then drives the acoustic output module to broadcast the selected acoustic data.

Preferably, the head up display further comprises an audio decompression module for decompressing the acoustic data.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

The subject matter regarded as the invention is particularly pointed out and distinctly claimed in the concluding portion of the specification. The invention, both as to device and method of operation, together with features and advantages thereof may best be understood by reference to the following detailed description with the accompanying drawings in which:

FIG. 1 illustrates a schematic diagram of the head up display in accordance with prior art,

FIG. 2 illustrates a block diagram of an embodiment of navigation system in accordance with the present invention,

FIG. 3 illustrates a schematic view of application of embodiment of navigation system in accordance with the present invention,

FIG. 4 illustrates a block diagram of an embodiment of the head up display in accordance with the present invention,

FIG. 5A illustrates a schematic view of an example of using VFD tubes to display navigation message, and

FIG. 5B illustrates a schematic view of another example of using VFD tubes to display navigation message.

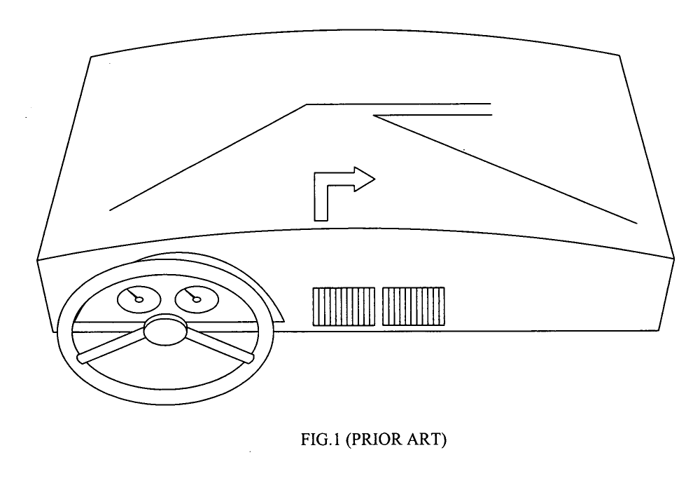

### DETAILED DESCRIPTION OF THE PREFERRED EMBODIMENT

The present invention relates to a navigation system and portable head up display thereof. While the specifications describe at least one embodiment of the invention considered best modes of practicing the invention, it should be understood that the invention can be implemented in many ways and is not limited to the particular examples described below or to the particular manner in which any features of such examples are implemented.

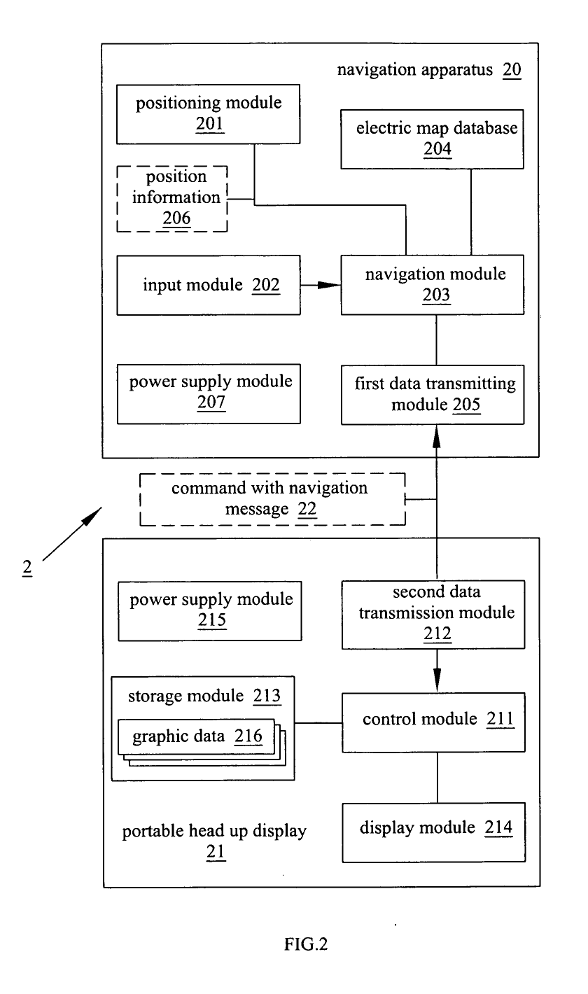

Please referring FIG. 2 for a block diagram of an embodiment of the navigation system in accordance with the present invention. The navigation system 2 comprises a navigation apparatus 20 and a portable head up display 21. The navigation apparatus 20 is for generating a command with navigation message 22, and comprises a positioning module 201, an input module 202, a navigation module 203, an electric map database 204, a first data transmitting module 205 and a power supply module 207. The power supply module 207 is for providing power for operation of the navigation apparatus 20. The power supply module 207 is preferably provided as, for example, a battery module or a motor vehicle rechargeable module. The positioning module 201 is for providing the position information 206 of the navigation apparatus 20, such as the coordinates or the longitude and latitude of the navigation apparatus 20, the positioning module 201 preferably comprises a GPS module, a digital compass or a gyroscope. The GPS module can receive a plurality of GPS signals from the GPS satellites, and calculate the longitude and latitude of its location based on these GPS signals. The digital compass is used to measure the directional orientation of the navigation apparatus 20, in particular when navigation apparatus 20 is rotating without significant displacement the digital compass and gyroscope can provide rotation information to supplement the weakness of the GPS module.

Electric map database 204 is for storing at least one digital map with road information. The input module 202 is for allowing user to enter a destination. The navigation module 203 then calculates a guidance route based on the digital map, a starting point and destination, wherein the starting point is usually the current location of the navigation module 203. Thereafter, based on the guidance route and the real time position information provided by positioning module 201, the navigation module 203 generates a command with navigation message 22 which, for example, can be “please turn left in 300 meters” or “the speed limit is 50 kilometer, please drive carefully,” etc. The navigation apparatus 20 transmits the command with navigation message 22 to portable head up display 21 via the first data transmission module 205. Preferably, the first data transmission module 205 can be a wireless signal transmission module such as a Bluetooth transmission module, a radio transmission module, a radio transmission module, or a wired transmission module such as an USB transmission module or an IEEE 1394 module.

Preferably, the navigation module 203 can be realized by the software means of executing an application program by processor, for example, the application program comprises a route planning program and a driving navigation program. Generally speaking, the navigation apparatus of the prior art displayes the navigation message on the screen, therefore the navigation apparatus of the prior art is not able to transmit the command with navigation message to the far end. However, this can be implemented by adding an outward transmission code in the driving navigation program. When executing the driving navigation program, the processor not only drives the monitor of the navigation apparatus to display the navigation message, but also generates the command with navigation message and transmits such command to data transmission module to the far end.

The navigation apparatus 20 illustrated above is an “on-board” model of navigation apparatus, where the positioning module and navigation module are assembled in the same case, here is an example, but is not limited thereto, whichever the apparatus has the capability of transmitting a command with navigation message is under the protection of present invention. For example, the navigation apparatus without built-in GPS module but GPS module can be externally connected to the navigation apparatus, this is under the protection of present invention herein. For example, the navigation apparatus without built-in digital map and navigation module, but such navigation module can be connected via wireless network to the navigation apparatus, this is also under the protection of present invention.

The portable head up display 21 is for displaying the graphic data corresponding to the navigation message, and comprises a control module 211, a second data transmitting module 212, a storage module 213, a display module 214 and a power supply module 215. The control module 211 is coupled to the second data transmitting module 212, the display module 214 and the storage module 213. The power supply module 215 is for providing power for operation of the head up display 21, and is preferably a battery module or a motor vehicle rechargeable battery module. The storage module 213 is for storing a plurality of graphic data 216. The storage module 213 preferably comprises a Read Only Memory(ROM), a Random Access Memory(RAM), a Flash memory or a memory built in the control module 211. The second data transmitting module 212 is for receiving the command with navigation message 22 and transmitting the command with navigation message 22 to the control module 211. The control module 211 processes and analyzes the command with navigation message 22 to obtain the navigation message and selects the graphic data 216 corresponding to the navigation message from the storage module 213, and then drives display module 214 to show the selected graphic data 216.

Preferably, the portable head up display 21 can comprise an acoustic output module 418, and the storage module 213 stores a plurality of acoustic data, and the control module 211 can select the acoustic data corresponding to the navigation message from the storage module 213, and drive the acoustic output module 418 to broadcast the selected acoustic data. If the acoustic data is the compression file, such as MP3 or WMA file, the portable head up display 21 can comprise an audio decompression module 417, such as the MP3 decoder chip or WMA decoder chip, for decompressing the compressed acoustic data.

The display module 214 comprises a display controller 4141 and at least one display component, the display controller 4141 controls the display component to display a desired graphic image based on the controlling signal form the controller module 211. The display component can be VFD tube, LED, LCD, TFT LCD, OLED LCD, STN LCD or DSTN LCD.

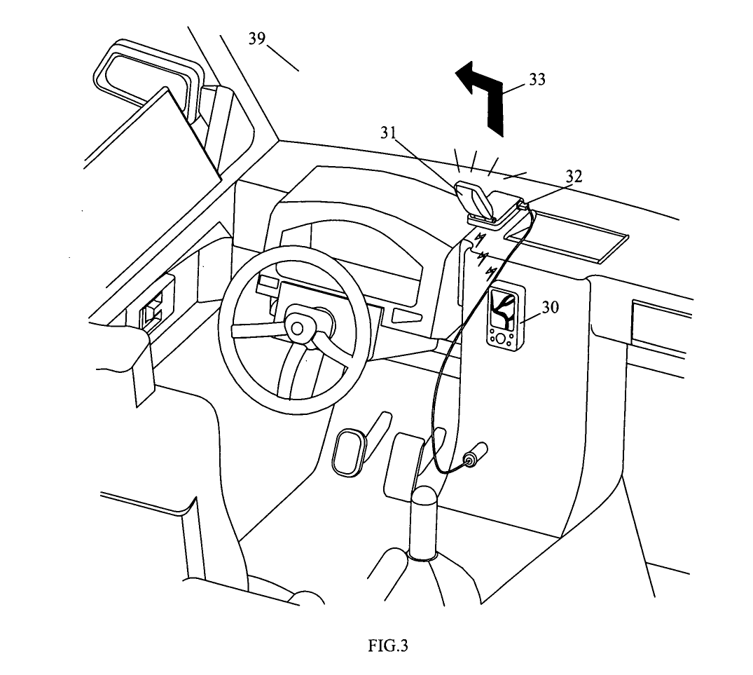

Please referring to FIG. 3 for a schematic view of application of an embodiment of the navigation system in accordance with the present invention, the navigation apparatus 30 transmits the command with navigation message to head up display 31 placed in front of the driver seat via Bluetooth communication. The head up display 31 obtains the navigation message after processing and analyzing the command, and then displays and projects the graphic image 33 corresponding to the navigation message to the windshield 39, a left turn indicator is illustrated. The power for operation of the portable head up display 21 is provided by motor vehicle rechargeable module 32 connected with a cigarette lighter.

It is known from the illustration above, if the user already owns a Personal Navigation Device (PND), such as a smart phone or a personal digital assistant with navigation function, and such PND can support an outward transmission for the command with navigation message, the user then can place the head up display 31 of present invention in the vehicle, to enjoy the efficacy of the navigation message displayed on the windshield, and the deficiency of indistinguishable graphic image owning to the smaller display size is subsequently resolved.

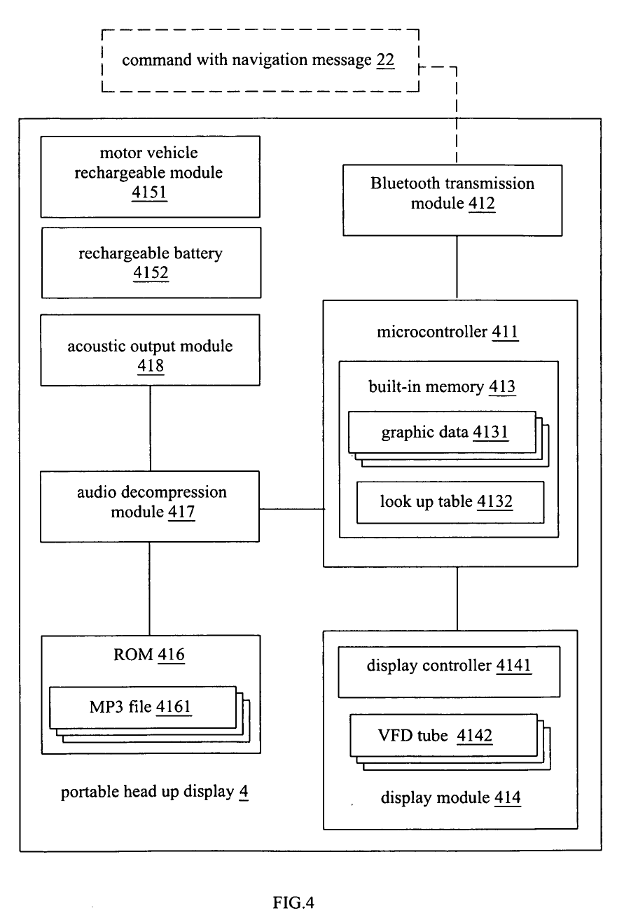

Please referring to FIG. 4 for a schematic view of other embodiment of the navigation system in accordance with the present invention, the portable head up display 4 comprises a microcontroller 411, a Bluetooth transmission module 412, a display module 414, a motor vehicle rechargeable module 4151, a rechargeable battery 4152, a ROM 416, an audio decompression module 417 and an acoustic output module 418. Wherein the ROM 416 stores a plurality of MP3 files 4161, and the display module 414 comprises a display controller 4141 and plurality VFD tubes 4142. The microcontroller 411 comprises a built-in memory 413, the built-in memory 413 stores a plurality of graphic data 4131 and a look up table 4132. The look up table 4132 records the mapping relationship of navigation message, graphic data 4131 and MP3 files 4161.

After receiving the command with navigation message 22, the Bluetooth transmission module 412 transmits the command with navigation message 22 to the microcontroller 411. The microcontroller 411 obtains the navigation message after processing and analyzing the received commands, and determines graphic data 4131 and MP3 files 4161 corresponding to the navigation message based on the look up table 4132. The microcontroller 411 then reads this corresponding graphic data 4131 from build-in memory 413 which then is transmitted to the display controller 4141. The display controller 4141 controls the brightness of each VFD tube 4142 to display the navigation message based on received graphic data 4131. Afterwards, the microcontroller 411 controls audio decompression module 417 to decompress the selected MP3 files 4161 stored in the ROM 416, and the decompressed analog acoustic data is then transmitted to acoustic output module 418 for broadcasting. It is noted that the described process of generation and output of analog acoustic data is with reference to the preferred embodiments, it is intended that the invention be not limited by any of the details of the description therein but includes all the embodiments which fall within the scope of the present invention.

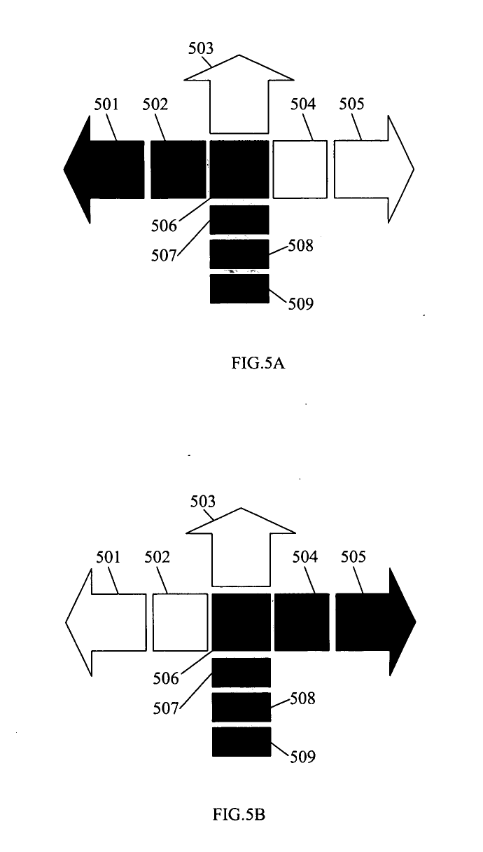

As illustrated in FIGS. 5A and 5B, the display controller 4141 can control the brightness of VFD tubes 501 to 509 independently, when VFD tubes 501, 502, 506, 507, 508 and 509 are lighted up and VFD tubes 503, 504 and 505 remains off, the VFD tubes is displaying a left turn graphic image as illustrated in FIG. 5A. When VFD tubes 504, 505, 506, 507, 508 and 509 are lighted up while VFD tubes 501, 502 and 503 remains off, the VFD tubes is displaying a right turn graphic image as illustrated in FIG. 5B. Herein the display module 414 has been described in a way of VFD tubes, it is to be understood that the invention is not limited thereto, display module 414 can use various display components to display navigation message, such as LED, LCD, TFT-LCD, OLED, STN LCD or DSTN LCD etc., each component has won control method and the corresponding display controller, such various changes and modifications herein are encompassed within the scope of the present invention.

Once the portable head up display 4 is placed in front of the windshield, the graphic image can be projected on the windshield glass. Because the location of the projected graphic image is in front of the driver seat, the driver can look the navigation message while driving, and this greatly reduces the accident risk led by the distraction of looking the navigation message.

While the invention has been described in a way of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A navigation system, comprising:
a navigation apparatus, for generating a command with a navigation message; and
a portable head up display, for receiving and processing said command with navigation message, and displaying said graphic data corresponding to said navigation message.

2. The navigation system of claim 1, wherein said head up display can broadcast an acoustic data corresponding to said navigation message.

3. The navigation system of claim 1, wherein said navigation apparatus comprises a wireless signal transmitting module transmitting said command to said portable head up display in wireless manner.

4. The navigation system of claim 3, wherein said wireless signal transmitting module is a Bluetooth transmitting module, a radio transmitting module or an infrared transmitting module.

5. The navigation system of claim 1, wherein said navigation apparatus comprises a wired signal transmitting module transmitting said command to said portable head up display in wired manner.

6. The system of claim 5, wherein said wired signal transmitting module is an USB transmitting module or an IEEE 1394 module.

7. The system of claim 1, wherein said navigation apparatus is a motor vehicle navigation device or a personal navigation device.

8. A head up display applied for displaying a navigation message from a remote navigation apparatus, comprising:
a power supply module, for providing power for operation of said head up display;
a data transmitting module, for receiving a command with said navigation message;
a display module, for displaying graphic image;
a storage module, for storing a plurality of graphic data; and
a control module, coupled to said data transmitting module, said display module and said storage module, wherein said control module processes said command to obtain said navigation message and selects the graphic data corresponding to said navigation message from said storage module, and drives said display module to show said selected graphic data.

9. The head up display of claim 8, further comprising an acoustic output module, and said storage module further storing a plurality of acoustic data, and said control module selecting the acoustic data corresponding to said navigation message from said storage module and driving said acoustic output module to broadcast said selected acoustic data.

10. The head up display of claim 9, further comprising an audio decompression module for decompressing said acoustic data.

11. The head up display of claim 10, wherein said audio decompression module is built in said control module.

12. The head up display of claim 8, wherein said display module comprises a display controller and at least one display component.

13. The head up display of claim 12, wherein said display component is VFD tube, LED, TFT LCD, OLED, LCD, STN LCD or DSTN LCD.

14. The head up display of claim 8, wherein said data transmitting module is a wireless signal transmitting module.

15. The head up display of claim 14, wherein said wireless signal transmitting module is a Bluetooth transmitting module, a radio transmitting module or an infrared transmitting module.

16. The head up display of claim 8, wherein said data transmitting module is a wired signal transmitting module.

17. The head up display of claim 16, wherein said wired signal transmitting module is an USB transmitting module or an IEEE1394 module.

18. The head up display of claim 8, wherein said storage module comprises a ROM, a RAM, a flash memory or a memory built in said control module.
